(19) United States
(12) Patent Application Publication
(10) Pub. No.: US 2024/0190657 A1
(43) Pub. Date: Jun. 13, 2024

(54) A STORAGE CONTAINER HANDLING SYSTEM AND A METHOD THEREOF

(71) Applicant: Autostore Technology AS, Nedre Vats (NO)

(72) Inventor: Jørgen Djuve Heggebø, Langhus (NO)

(73) Assignee: Autostore Technology AS, Nedre Vats (NO)

(21) Appl. No.: 18/286,977

(22) PCT Filed: Apr. 8, 2022
(86) PCT No.: PCT/EP2022/059385

§ 371 Date: Oct. 13, 2023

(30) Foreign Application Priority Data
Apr. 30, 2021 (NO) 20210535

(51) Int. Cl. B65G 1/137; B65G 1/04

(52) U.S. Cl. CPC B65G 1/1375; B65G 1/0478; B65G 1/0492

(57) ABSTRACT

A storage container handling system includes a base, a remotely operated vehicle, and a storage station. The remotely operated vehicle includes rollers configured to operate the remotely operated vehicle on the base. The remotely operated vehicle includes at least one container carrier configured to carry a storage container. The storage station stores a storage container that is to be picked-up by or dropped off by the remotely operated vehicle. The storage station includes a container support, a delivery position, and an elevating system. The container support is configured to support the storage container. The delivery position is for the remotely operated vehicle picking-up or dropping off the storage container. The elevating system is configured to lift and lower the container support between a transfer position and a storage position. The transfer position is where the storage container can be picked-up or dropped off by the remotely operated vehicle. The storage position is where the storage container can be stored off the remotely operated vehicle on the container support. The elevating system is a vertical elevating system configured to lift and lower the container support vertically between the transfer position and the storage position such that, when the remotely operated vehicle is in the delivery position at the storage station and the container support is in the transfer position, the storage container may be transferred between the remotely operated vehicle and the container support of the storage station. The elevating system is powered by mechanical power transmitted from the rollers of the remotely operated vehicle.

### FIELD OF THE INVENTION

The present invention relates to an automated storage and retrieval system for storage and retrieval of containers, in particular to a storage container handling system comprising a storage station and a method of transferring a storage container between a remotely operated vehicle and the storage station of a storage container handling system.

### BACKGROUND AND PRIOR ART

FIG. 1 discloses a typical prior art automated storage and retrieval system 1 with a framework structure 100 and FIGS. 2-3 disclose two different prior art container handling vehicles 200,300 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked so as to form container stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301 is operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 200,300 in a first direction X across the top of the frame structure 100, and a second set of parallel rails 111 arranged perpendicular to the first set of rails 110 to guide movement of the container handling vehicles 200,300 in a second direction Y which is perpendicular to the first direction X. Containers 106 stored in the columns 105 are accessed by the container handling vehicles through access openings 112 in the rail system 108. The container handling vehicles 200,300 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 200,300 comprises a vehicle body 201,301, and first and second sets of wheels 202a,302a,202b,302b which enable the lateral movement of the container handling vehicles 200,300 in the X direction and in the Y direction, respectively. In FIGS. 2 and 3 two wheels in each set are fully visible. The first set of wheels 202a,302a is arranged to engage with two adjacent rails of the first set 110 of rails, and the second set of wheels 202b,302b is arranged to engage with two adjacent rails of the second set 111 of rails. At least one of the sets of wheels 202a,302a,202b,302b can be lifted and lowered, so that the first set of wheels 202a,302a and/or the second set of wheels 202b,302b can be engaged with the respective set of rails 110, 111 at any one time.

Each prior art container handling vehicle 200,300 also comprises a lifting device (not shown) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 200,300 so that the position of the gripping/engaging devices with respect to the vehicle 201,301 can be adjusted in a third direction Z which is orthogonal the first direction X and the second direction Y. Parts of the gripping device of the container handling vehicle 200 are shown in FIG. 2 indicated with reference number 210. The gripping device of the container handling device 300 is located within the vehicle body 301 in FIG. 3.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 200,300 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 200,300 comprises a storage compartment or space for receiving and stowing a storage container 106 when transporting the storage container 106 across the rail system 108. The storage space may comprise a cavity arranged centrally within the vehicle body 301 as shown in FIG. 3 and as described in e.g. WO2015/193278A1, the contents of which are incorporated herein by reference.

FIG. 2 shows an alternative configuration of a container handling vehicle 200 with a cantilever construction. Such a vehicle is described in detail in e.g. NO317366, the contents of which are also incorporated herein by reference.

The central cavity container handling vehicles 300 shown in FIG. 3 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 300 may have a footprint which is larger than the lateral area defined by a storage column 105, e.g. as disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 200,300 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 200,300 can drop off storage containers 106 to be transported to an access or a transfer station, and the second port column 120 may be a dedicated pick-up port column where the container handling vehicles 200,300 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as described in WO2014/075937A1, the contents of which are incorporated herein by reference.

When a storage container 106 stored in one of the columns 105 disclosed in FIG. 1 is to be accessed, one of the container handling vehicles 200,300 is instructed to retrieve the target storage container 106 from its position and transport it to the drop-off port column 119. This operation involves moving the container handling vehicle 200,300 to a location above the storage column 105 in which the target storage container 106 is positioned, retrieving the storage container 106 from the storage column 105 using the container handling vehicle's 200,300 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 200,300 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 200,300 is instructed to pick up the storage container 106 from the pick-up port column 120 and transport it to a location above the storage column 105 where it is to be stored. After all storage containers 106 positioned at or above the target position within the stack 107 have been removed, the container handling vehicle 200,300 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 200,300 so that a desired storage container 106 can be delivered to the desired location at the desired time without the container handling vehicles 200,300 colliding with each other, the automated storage and retrieval system 1 comprises a control system 500 which typically is computerized and which typically comprises a database for keeping track of the storage containers 106.

EP3647231A1 discloses a transport vehicle that travels between rows of shelved containers. The vehicle comprises a transfer apparatus that transfers the containers between the vehicle and the passive shelves and a lifting mechanism that may lift containers. The vehicle travels on a one-dimensional guide rail provided in the floor surface and is specifically built to operate along a single direction.

Solutions pertaining to state of the art are also disclosed in US2016207711A1, GB1467343A, WO2016172253A1 and EP3170771A1.

A further problem associated with known automated storage and retrieval system is that pick-up and drop off operations of storage containers between vehicles can be time consuming.

Cooperating vehicles, for example a delivery vehicle and a container handling vehicle, that must exchange a storage container, may not be available at the same time for this operation. This results in one vehicle having to wait for the other vehicle to transfer the storage container, thereby causing inefficiencies and reducing the operational cycle of the storage system as a whole.

In view of the above, it is desirable to provide an automated storage and retrieval system, and a method for operating such a system, that solve or mitigate the aforementioned problems related to use of prior art storage and retrieval system.

An objective is to provide an automated storage and retrieval system that increases the availability of container handling vehicles and delivery vehicles operating on a rail system.

Yet another objective is to provide an automated storage and retrieval system which increases the efficiency and facilitates the operation of transferring storage containers between vehicles.

### SUMMARY OF THE INVENTION

The present invention is set forth and characterized in the independent claims, while the dependent claims describe other characteristics of the invention.

In a first aspect, the invention is related to a storage container handling system comprising a base, a storage station, and a remotely operated vehicle operating on the base.

The remotely operated vehicle comprises rolling means configured to operate remotely operated vehicle on the base. The remotely operated vehicle further comprises at least one container carrier configured to carry a storage container.

The storage station is for storing a storage container that is to be picked-up by or dropped off by the remotely operated vehicle. The storage station comprises a container support configured to removably support or hold the storage container, a delivery position for the remotely operated vehicle picking-up or dropping off the storage container, and an elevating system.

The elevating system is configured to lift and lower, or to move, the container support between a transfer position, where the storage container can be picked-up or dropped off by the remotely operated vehicle, and a storage position, where the storage container can be stored off the remotely operated vehicle on the container support.

The elevating system is a vertical elevating system configured to lift and lower the container support vertically between the transfer position and the storage position such that, when the remotely operated vehicle is in the delivery position at the storage station and the container support is in the transfer position, the storage container may be transferred between the remotely operated vehicle and the container support of the storage station.

The base may be a rail system, a track system, a floor, or any other suitable base.

The remotely operated vehicle may be a robot cart (commonly referred to in the technical field as a drone or robot cart), an automated guided vehicle (AGV), a pick-up vehicle, and/or a prior art container handling vehicle available with a cantilever or central cavity as described above.

The rolling means of the remotely operated vehicle may be wheels or continuous tracks for example caterpillars' tracks, or other any suitable rolling means. The rolling means may be arranged around the periphery of the rolling base unit.

The remotely operated vehicle comprises at least one container carrier configured to carry at least one storage containers. The at least one container carrier is for removably supporting, holding or suspending the storage container. For example, the container carrier may carry the storage container by supporting the storage container from below, or by suspending the storage container from its top edges, or by holding the storage container from at least two opposite sides of the storage container.

The storage station comprises a delivery position for the remotely operated vehicle picking-up and dropping the storage container. When the remotely operated vehicle is moved to the delivery position, the container carrier is also in a delivery position. In the delivery position, the container carrier and the container support are substantially vertically aligned and both the container carrier and the container support are adjacent to the storage container. In the delivery position the weight of the storage container can be transferred between the container carrier and the container support of the storage station by lifting or lower the container support.

The elevating system moves the container support between a transfer position and a storage position. In the transfer position the storage container can be picked-up or dropped off by the remotely operated vehicle. In the storage position, the storage container can be stored off the remotely operate vehicle on the container support.

The transfer position may be above or below the storage position, depending on how the storage container is carried by the container carrier. If the storage container is carried from its top edges by the container carrier, then the transfer position is above the storage position. If the storage container is carried from below by the container carrier, then the storage position is above the transfer position.

The elevating system may be any system capable of lifting and lowering the container support. The elevating system, for example a rack and pinion assembly, hydraulic or pneumatic assembly, or liner screws, configured to lift and lower the container support.

As described above, the elevating system maybe a vertical elevating system configured to lift and lower the container support vertical between the transfer position and the storage position.

Alternatively, the elevating system may be a pivot assembly to lift and lower the container support pivotally between the transfer position and the storage position. The pivotal movement may linear or rotational.

The invention advantageously allows to store/hold a storage container, for example in the event a remotely operated vehicle is not ready to receive a storage container from another remotely operated vehicle.

Another advantage of the invention is that different type of remotely operated vehicles, for example such as those of the cantilever or central cavity vehicles (200,300) from the prior art and/or a drone vehicle (400), may exchange storage containers via the temporary storage.

The storage station may be arranged at, or adjacent to, a perimeter of the base, for example, integrated within a port or a grid interface of a storage grid. In general, the storage station may be placed anywhere on or outside the base as long as the storage station is within reach of the remotely operated vehicle.

The storage station, when arranged for example at a port, allows a remotely operated vehicle to drop a storage container and temporary store that storage container, so that pick operations can be performed by an operator or a robot without the delivery vehicle having to be necessarily present at the port. The remotely operated vehicle thereby becomes available to perform other tasks, thus increasing the vehicle availability and efficiency of the storage system.

The storage station may be one or a plurality of storage stations. The plurality of storage stations may be arranged adjacent to each other or separated from each other.

In one embodiment of the system, the elevating system may be a vertical elevating system configured to lift and lower the container support vertically between the transfer position and the storage position. The elevating system may be any system capable of moving vertically the container support, for example a rack and pinion assembly, hydraulic or pneumatic assembly, or liner screws, configured to lift and lower the container support vertically.

In one embodiment of the system, the elevating system is a pivot assembly configured to lift and lower the container support pivotally between the transfer and storage positions. The pivot assembly may lift and lower the container support using a linear or rotational movement. The pivot assembly may be a rack and pinion assembly, hydraulic or pneumatic assembly, configured to move the container carrier vertically between the upper and lower position.

In one embodiment of the system, the elevating system may be powered by electrical power transmitted from a battery onboard the remotely operated vehicle. In such an embodiment, a first power connector may be arranged on the vehicle and a second power connector may be arranged on the storage station, such that electrical power from the battery of the remotely operated vehicle can be transmitted from the first connector to the second connector. The second power connector may be connected to a control device/system, wherein the control device/system is connected to a motor driving the elevating system. The control device/system may be configured to receive instructions from another control system onboard the remotely operated vehicle, and/or it may be configured to receive instructions from the control system of the automated storage and retrieval system as described above.

In one embodiment of the system, the elevating system may be powered by electrical power transmitted from a power grid. In this embodiment, the storage station is connected to an electrical power grid. The storage station may comprise a control device powered by electricity from the power grid. The control device may be connected to a motor driving the elevating system to move the container support.

In one embodiment of the system, the elevating system may be powered by mechanical power transmitted from rolling means of the remotely operated vehicle. The elevating motion may be driven by mechanical power transmitted from the rolling means of the remotely operated vehicle, for example if the rolling means are a set of wheels, or by spinning the wheels on spindles, for rotating the spindles. In such an alternative, a rotational force is transmitted from the spindle to a shaft connected to the elevating system. The rotational force transmitted to the shaft is used as a mechanical force to drive the elevating system such that it can lift and lower the container support.

In one embodiment of the system, the container support may be configured to support the storage container from below. The container support may have the form for example of a plate or two arms to support the storage container stability from its below surface. For example, the container may comprise pins protruding vertically from an upper surface of the container support to interact with corresponding holes below the storage container, such that when the storage container is supported onto the container support, the pins ensure that the storage container remains in stable position on the container support.

When the container support is in a transfer position and the remotely operated vehicle is moved onto the base to the delivery position at the storage station, the vehicle can interact with the container support such that the storage container, supported by the vehicle, is positioned above the container support. The container support can then be lifted or lowered to the storage position, wherein the storage container is picked-up off the remotely operated vehicle, i.e. the weight of the storage container is transferred from being supported by the remotely operated vehicle to being supported by the container support. The reverse operation can be carried out for the vehicle to pick up a storage container from the storage station.

In one embodiment of the system, the container support may be configured to support the storage container from lower edges of the storage container. The container support may be two arms with a horizontal separation. The separation between the two arms is preferably near or larger than the width of the storage container. The two arms preferably have an L-shape to stably support the storage container from its lower edges.

In one embodiment of the system, the container support is configured to support the storage container from upper edges of the storage container. In such an embodiment, the container support may be configured to support/hold the storage container from at least a part of the upper edges of the storage containers.

In a preferred alternative of the system, the container support may comprise a gripping device configured to interact with corresponding holes of the storage container. Alternatively or additionally, the container support may comprise a clamping device configured to hold the storage container from at least two opposite sides.

In one embodiment of the system, the container support may be tiltable. In such an embodiment it is preferred not to store a storage container on the container support.

This advantageously allows vehicles operating on the base to move near the station without colliding with the container support.

In one embodiment of the system, the storage station may be fixed to a pedestal. In another preferred embodiment, the pedestal is height-adjustable relative to the base. In yet another preferred embodiment, the pedestal may be rotatable around its longitudinal axis. The rotating pedestal may be affixed to the base such that when the pedestal rotates the container support of the station is moved over the base. Having a rotating pedestal makes it possible to change the position of the container support over the base and makes it accessible by the remotely operated vehicle from different locations/positions on the base.

In one embodiment of the system, the base is a two-dimensional rail system comprising a first set of parallel rails arranged in a horizontal plane (P) and extending in a first direction (X) and a second set of parallel rails arranged in the horizontal plane (P) and extending in a second direction (Y) which is perpendicular to the first direction (X). The first and second sets of rails forms a grid pattern in the horizontal plane (P) comprising a plurality of adjacent grid cells, each grid cell comprising a grid opening.

In other words, the base may be for example a rail system 108 as described in the background chapter further above.

In one embodiment of the system, an automated storage and retrieval system comprising a storage container handling system according to any one of the exemplary embodiments described above, and an upper two-dimensional rail system arranged above the base of the storage container handling system. The upper two-dimensional rail system comprises a first set of parallel rails arranged in a horizontal plane (P) and extending in a first direction (X), and a second set of parallel rails arranged in the horizontal plane (P) and extending in a second direction (Y) perpendicular to the first direction (X). The first and second sets of rails form a grid pattern in the horizontal plane (P) comprising a plurality of adjacent grid cells, each grid cell comprising a grid opening. The automated storage and retrieval system further comprises a plurality of stacks of storage containers arranged in storage columns beneath the upper rail system, wherein each storage column is located vertically below the grid opening. The automated storage and retrieval system further comprises a container handling vehicle comprising a lifting device for lifting a storage container stacked in the stacks and configured to drive the vehicle along the upper rail system in at least one of the first direction (X) and the second direction (Y). In addition, the automated storage and retrieval system also comprises a delivery column for transport of the storage container between the upper rail system and the storage station, wherein the storage station is arranged at the base at the lower end of the delivery column.

In other words, the storage station may be arranged for example at the lower end of a delivery column 119,120 of an automated storage and retrieval system 1 as described in the background chapter further above. In this configuration, the container support can receive a storage container dropped by remotely operated vehicle moving on the base, or dropped by a container handling vehicle moving on the upper rail system.

Having a storage station arranged at the lower end of a delivery column allows to temporary store a storage container in the event the remotely operated vehicle is not ready to receive a storage container from a container handling vehicle, or if the container handling vehicle is not ready for retrieving the storage container from the delivery vehicle.

In one embodiment of the system, an automated storage and retrieval system comprises:
a storage container handling system, wherein the base is a two-dimensional rail system as described above,
a plurality of stacks of storage containers arranged in storage columns beneath the rail system, wherein each storage column is located vertically below the grid opening and
a container handling vehicle comprising a lifting device for lifting a storage container stacked in the stacks and configured to drive the vehicle along the rail system in at least one of the first direction (X) and the second direction (Y),
   wherein the storage station is fixed on the two-dimensional rail system.

In a second aspect, the invention concerns a method of transferring a storage container between a remotely operated vehicle and a storage station of a storage container handling system as described above, wherein the remotely operated vehicle is configured to move on the base and wherein the elevating system is a vertical elevating system configured to lift and lower the container support vertically between the transfer position and the storage position.

A central computer may be arranged to control and execute the steps of:
a) operating the elevating system such that the container support is in the transfer position,
b) moving the remotely operated vehicle to the delivery position at the storage station;
c) transferring the storage container from the remotely operated vehicle to the container support of the storage station by operating the elevating system to vertically move the container support from the transfer position to the storage position and
d) moving the remotely operated vehicle in an opposite direction relative to step b), thereby leaving the storage container at the storage station.

The steps above describe the transfer of a storage container from a position on the remotely operated vehicle to a position on the storage station.

In step a) the elevating system is operated to move the container support in the transfer position, i.e. the container support is moved at a distance above or below the base surface such that the container support can received a storage container from a remotely operated vehicle.

In step b) the remotely operated vehicle is move onto the base to a delivery position at the storage station. In the delivery position, the container support, the container carrier and the storage container are vertically aligned.

As a preferred step, if needed, the container carrier (1210) of the remotely operated vehicle may be adjusted in the delivery position.

If the vehicle is a cantilever vehicle or a central cavity vehicle available from the prior art, step b) will additionally involve the step of releasing the storage container from the gripping device of the cantilever vehicle, such that the storage container can safely be dropped onto the container support.

In step c) the elevating system moves the container support from a transfer position to a storage position, in this process the weight of the storage container is transferred from being supported by the container carrier of the vehicle to being supported by the container support of the station.

Further, the storage position is at a distance from the base such that the vehicle may reverse in step d) without colliding with the station.

Similar steps may be used, albeit in a different order, to transfer a storage container from the storage station to the remotely operated vehicle, i.e.:

In a first step, the container support is in a storage position and the remotely operated vehicle is move onto the base to a delivery position at the storage station. In the delivery position, the container support, the container carrier and the storage container are vertically aligned.

In a second step, the elevating system is operated to move the container support to the transfer position, i.e. the container support is moved at a distance above or below the base surface such that the storage container can be received by a remotely operated vehicle.

In third step, the weight of the storage container is transferred from being supported by the container support to being supported by the container support of the station. If the vehicle is a cantilever vehicle or a central cavity vehicle available from the prior art, this third step will additionally involve the step of activating the gripping device of the vehicles in order to grip the storage container, such that the storage container can safely be picked-up by the container carrier of the vehicle. The container support can then be moved to the storage position.

Further, the storage position is at a distance from the base such that the vehicle may reverse in step d) without colliding with the station.

In the following, numerous specific details are introduced by way of example only to provide a thorough understanding of embodiments of the claimed system and method. One skilled in the relevant art, however, will recognize that these embodiments can be practiced without one or more of the specific details, or with other components, systems, etc. In other instances, well-known structures or operations are not shown, or are not described in details to avoid obscuring aspects of the disclosed embodiments.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a cantilever for carrying storage containers underneath.

FIG. 3 is a perspective view of a prior art container handling vehicle having a centrally arranged cavity for carrying storage containers therein.

FIG. 4 is a perspective view of a delivery vehicle arranged for transporting a storage container.

FIGS. 5A-H are perspective views of an exemplary embodiment of the invention wherein the remotely operated vehicle is a delivery vehicle as shown in FIG. 4.

FIGS. 6A-C are perspective views of an exemplary embodiment of the invention wherein the remotely operated vehicle is a cantilever vehicle as shown on FIG. 2.

FIGS. 7A-C are perspective views of an exemplary embodiment of the invention, wherein the elevating system is a vertical elevating system powered by mechanical power transmitted from rolling means of the delivery vehicle.

FIGS. 8A-B are perspective views of an exemplary embodiment of the invention, wherein the elevating system is a vertical elevating system powered by electrical power transmitted from a battery onboard the delivery vehicle.

FIG. 9 is a perspective views of an exemplary embodiment of the invention, wherein the elevating system is a vertical elevating system powered by electrical power transmitted from a power grid.

FIGS. 10A-B are perspective views of an exemplary embodiment of the invention wherein the container support is configured to hold the storage container from the top using a clamping mechanism.

FIGS. 11A-E are perspective views of alternatives configurations of the container support carrying a storage container from the upper edges of the storage container.

FIGS. 12A-F are perspective views of an exemplary embodiment of the invention wherein the elevating system is a pivot assembly.

FIGS. 13A-D are perspective views of an exemplary embodiment of the invention wherein the storage station can be lowered below the base.

FIGS. 14A-B are perspective views of an exemplary embodiment of the invention wherein the storage station is fixed to a pedestal.

FIG. 15A-D are perspective views of an automated storage and retrieval system where the storage station of FIG. 5 is arranged below a delivery column.

FIG. 16 is a perspective view of an automated storage and retrieval system wherein the storage station of FIG. 13 is arranged below a delivery column.

FIG. 17 is a perspective view of an automated storage and retrieval system wherein the storage station of FIG. 14A is arranged below a delivery column.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

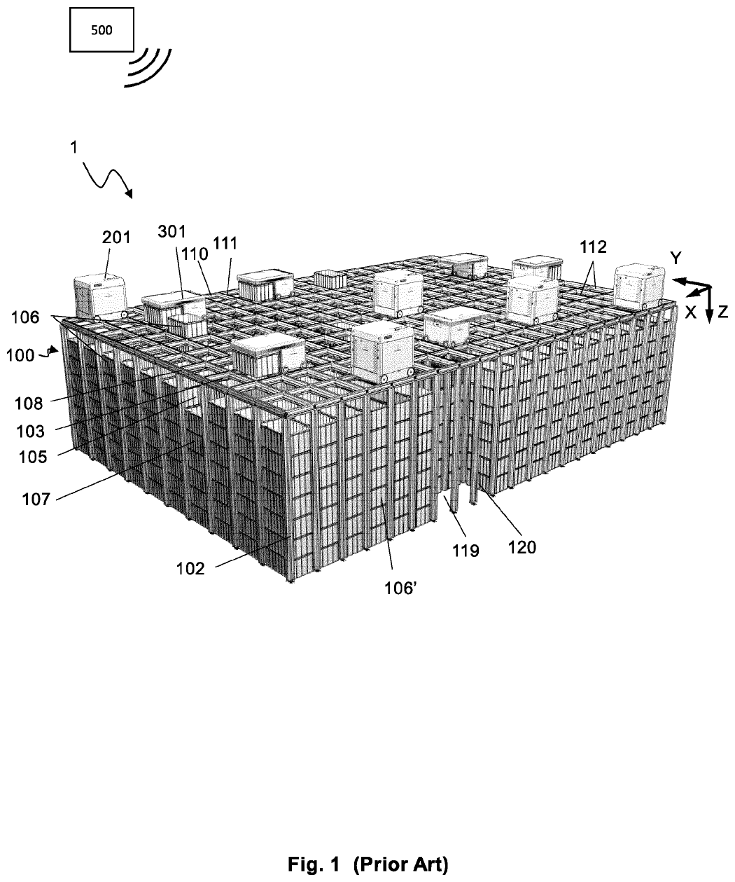

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

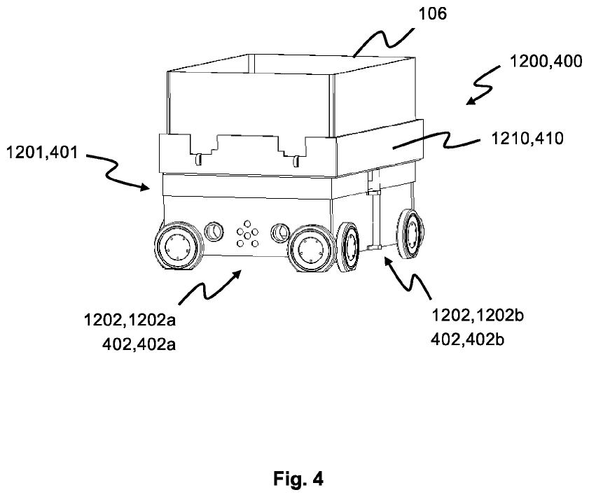

FIG. 4 shows one possible version of a remotely operated vehicle 1200. In FIG. 4, the remotely operated vehicle 1200 is shown as a delivery vehicle 400.

The delivery vehicle 400 is configured for transport of a storage container 106. The delivery vehicle 400 comprises: a vehicle body 401, at least one rolling means 402,402a,402b connected to the vehicle body 401, at least one rolling means motor (not shown) for driving the rolling means 402,402a,402b in a horizontal plan P, and a power source (not shown) connected to the rolling means motor (not shown). The power source should provide sufficient power to the rolling means motor to propel the rolling means 402,402a,402b on a base.

The delivery vehicle 400 may further comprise a container carrier 410 mounted above the vehicle body 401. The container carrier 410 should be configured to receive the storage container 106, for example, onto or within the container carrier 410, such that the storage container 106 is prevented from sliding from the delivery vehicle 400.

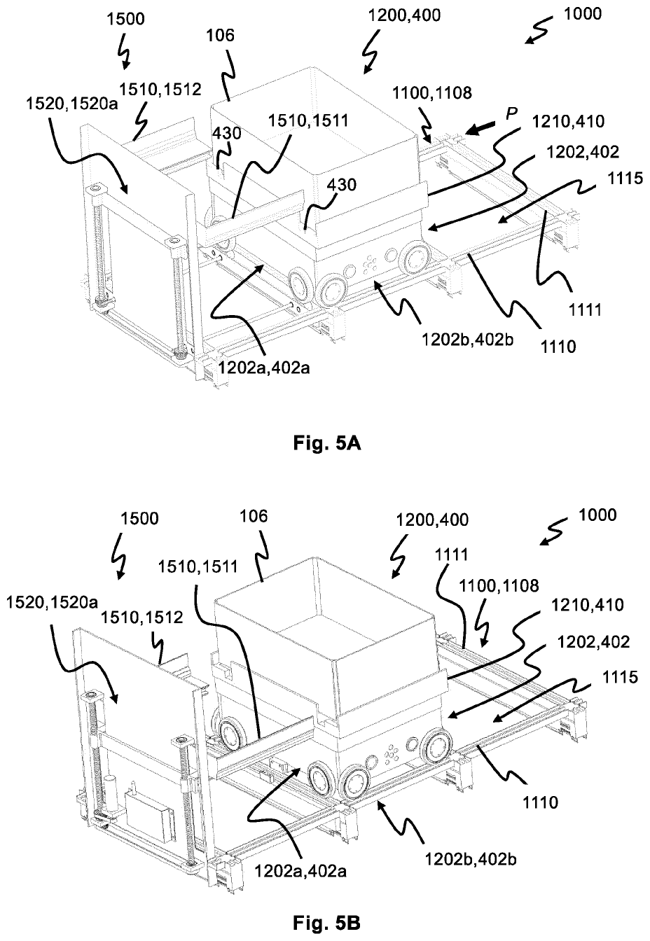

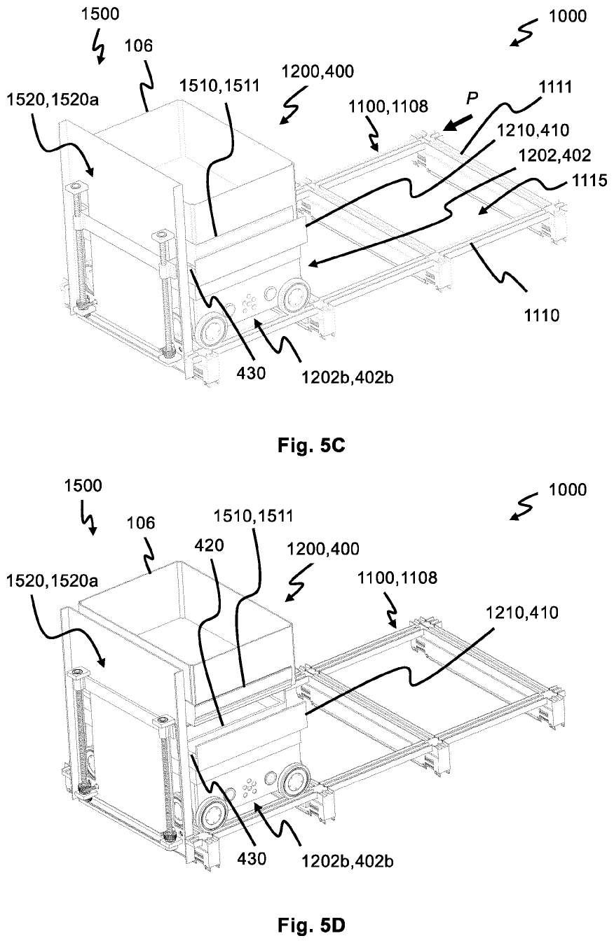

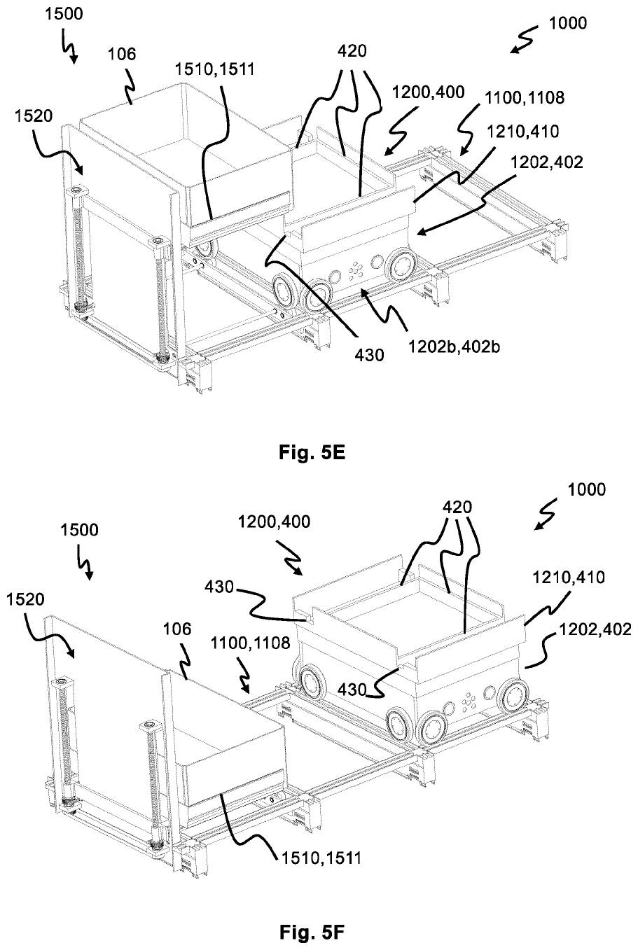

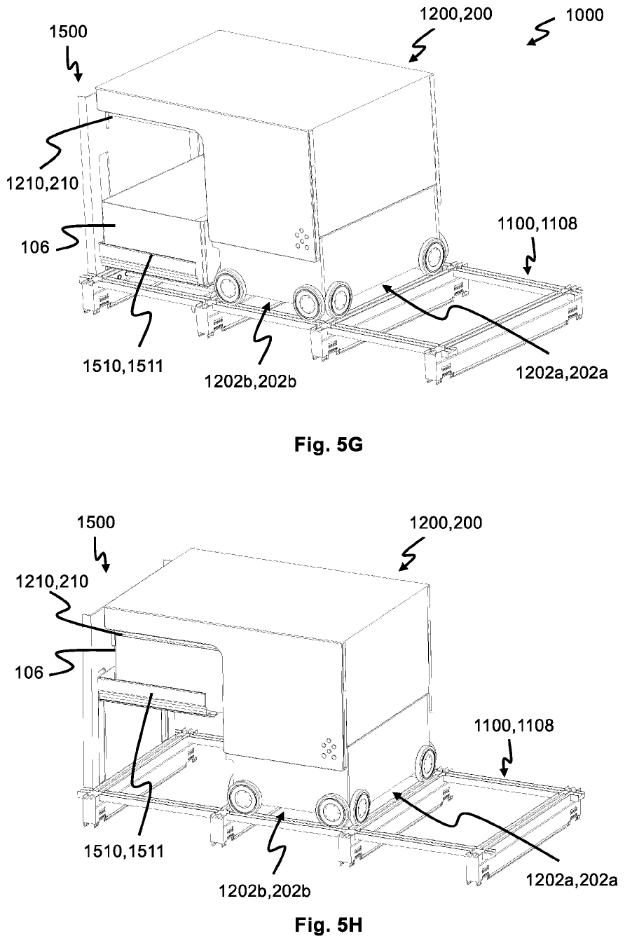

The container carrier 410 may comprise a container supporting device 420 (as shown on FIG. 5E) supporting the storage container 106 from below.

In FIG. 4, the container carrier 410 is disclosed in the form of a storage container receiving compartment having a bottom/base and side walls. The volume of the compartment is shown in this exemplary configuration such that it may receive and contain the entire horizontal extent of the storage container 106 and at least a part of the vertical extent of the storage container 106.

The particular configuration of the container carrier 410 disclosed in FIG. 4 allows the delivery vehicle 410 to transport storage containers 106 having different heights.

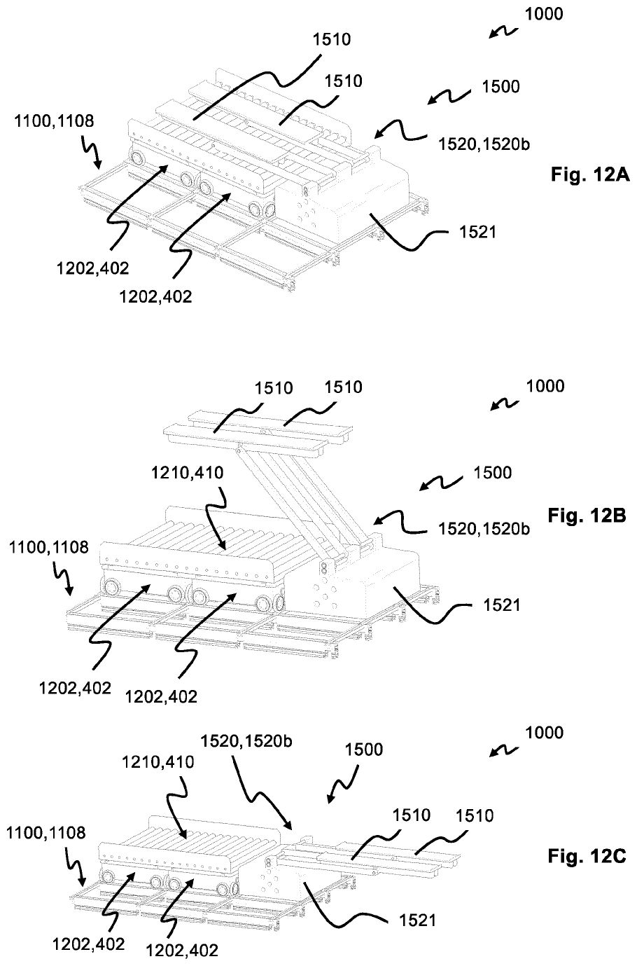

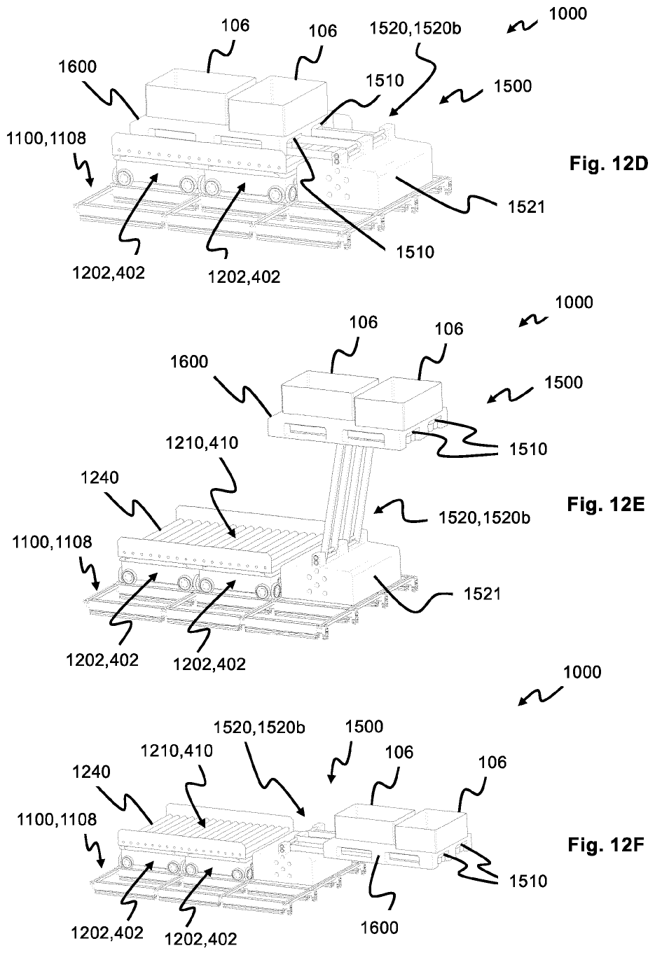

It is to be noted that the size of the compartment within the container carrier 410 may easily be adapted for receiving and supporting a multiple number of storage containers 106 in one operation, as shown in FIG. 12. In the configuration shown in FIG. 12, the container carrier 410 comprises a base plate, a conveyor arranged on the base plate and two side walls protruding upwards from the base plate. The rolling means 402,402a,402b, and the vehicle body 401 are the same as or similar to the rolling means 402,402a,402b and the vehicle body 401 described above. The conveyor may be set up by inter alia a plurality of parallel oriented rolls 430 having a common longitudinal direction perpendicular to the two side walls. In this way, the rolls 430 allow one or more storage containers 106 to be shifted on or off the container carrier 410 while being guided by the side walls. The conveyor may be connected to a conveyor motor allowing rotation of one or more of the rolls.

Reference is made to FIGS. 5A-H showing one exemplary embodiment of a storage container handling system 1000 according to the present invention. The storage container handling system 1000 comprising a base 1100, a storage station 1500, and a remotely operated vehicle 1200 operating on the base 1100.

In FIGS. 5A-H, the base 1100 is shown as a rail system 1108, similar or identical to the rail system 108 as described above. Alternatively, the base 1000 may be a track system, a floor, or any other suitable base 1000.

The remotely operated vehicle 1200 comprises rolling means 1202,1202a, 1202b configured to operate the remotely operated vehicle 1200 on the base 1100. The remotely operated vehicle 1200 further comprises at least one container carrier 1210 configured to carry a storage container 106.

In the exemplary embodiment shown in FIGS. 5A-F, the remotely operated vehicle 1200 is shown as a delivery vehicle 400 as described above, comprising a container carrier 1210,410 in the form of a storage container receiving compartment having a bottom/base and side walls.

The container carrier 1210,410 may comprise recesses 430 configured to interact with the container support 1510 of the storage station 1500 as further described below.

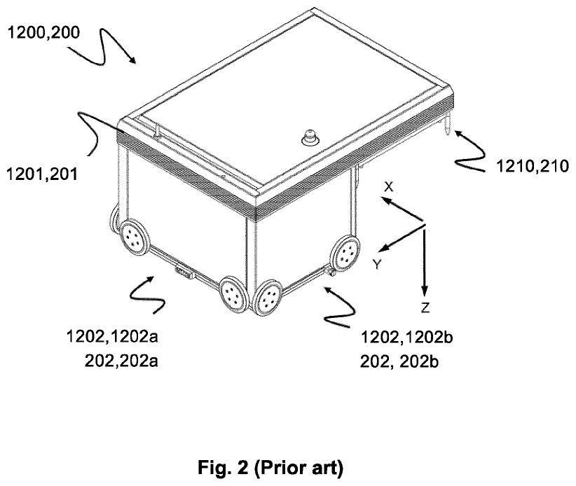

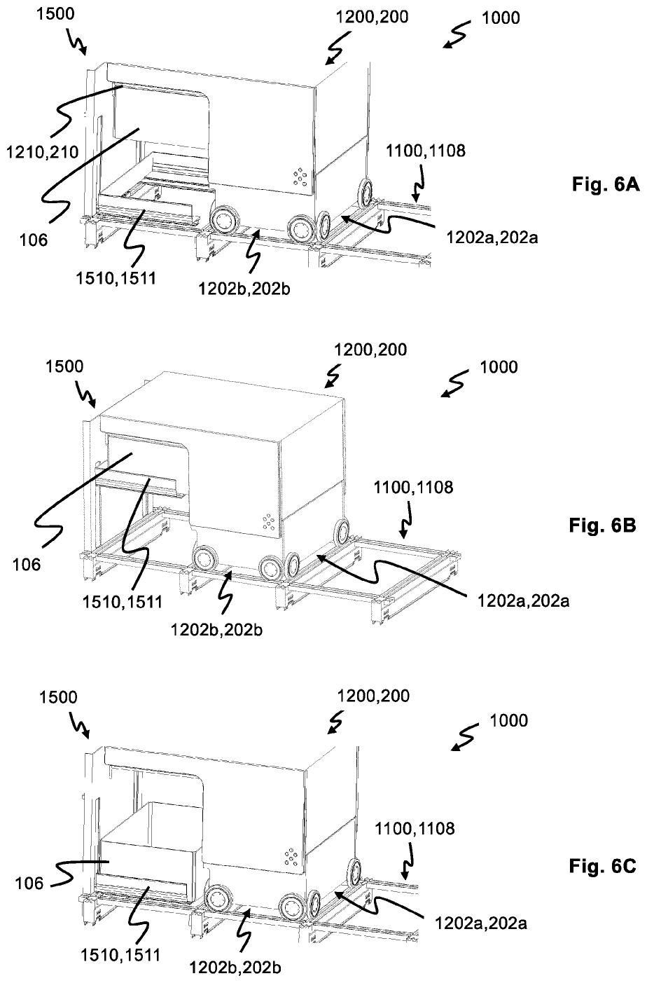

Although FIGS. 5A-F illustrate the remotely operated vehicle 1200 as a delivery vehicle 400, it should be understood that the remotely operated vehicle 1200 may instead be a cantilever vehicle 200 as shown in FIG. 2, FIGS. 5 G-H and FIGS. 6A-C, comprising a container carrier 1210,210.

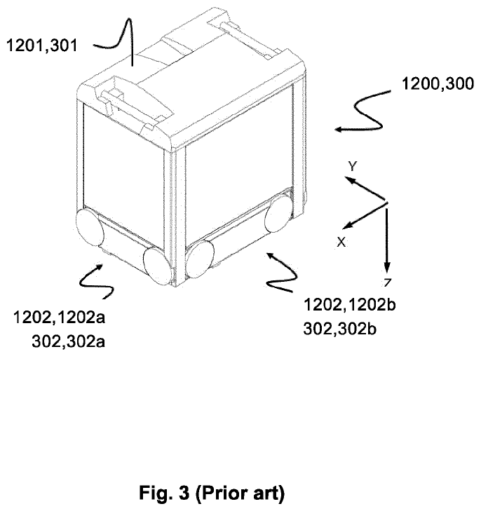

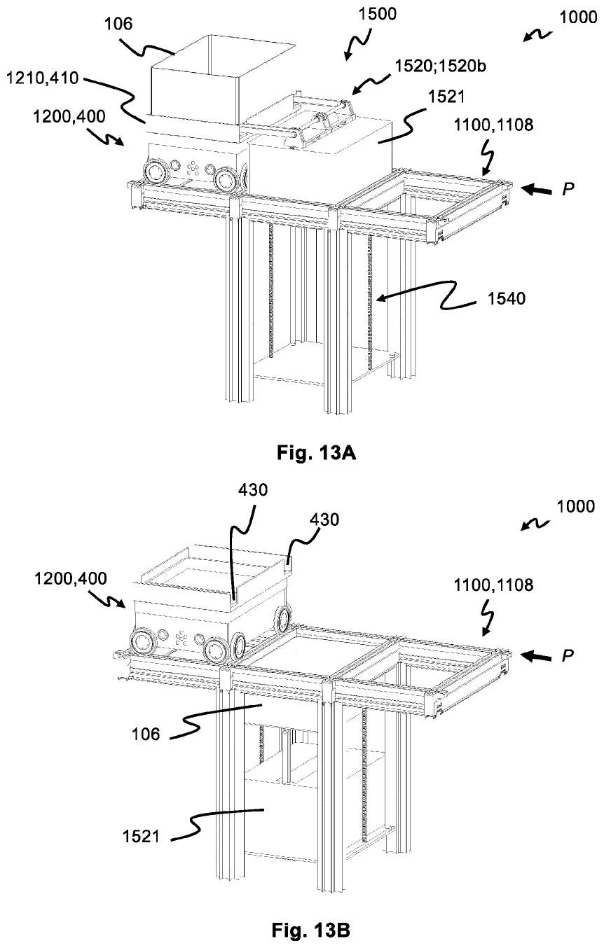

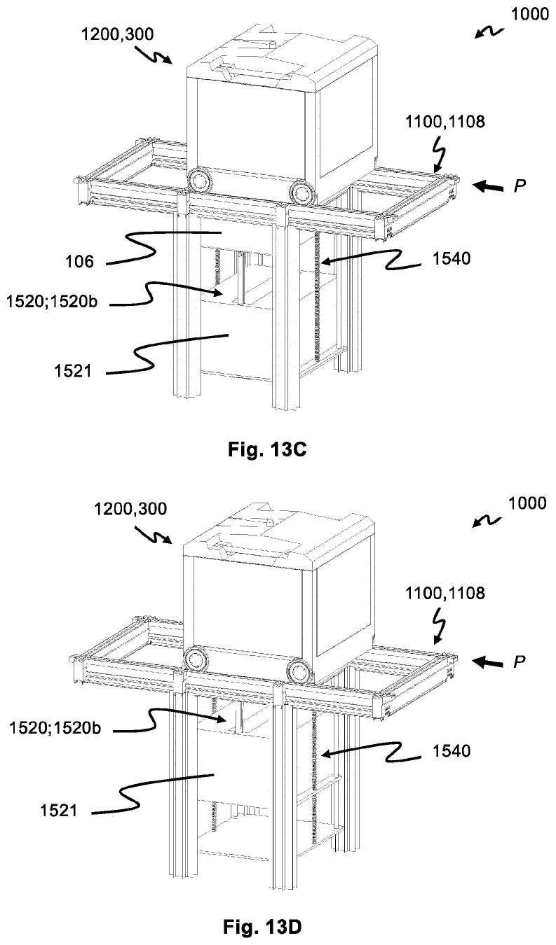

Alternatively, the remotely operated vehicle 1200 may be a central cavity vehicle 300 as shown in FIG. 3 and FIG. 13, comprising a container carrier 1210,310 (not shown).

Alternatively, the remotely operated vehicle may be an automated guided vehicle comprising a container carrier.

In yet another alternative, the remotely operated vehicle may be a pick-up vehicle having at least two container carriers 1210.

The storage station 1500 is for storing a storage container 106 that is to be picked-up by or dropped-off by the remotely operated vehicle 1200,200,300,400. The storage station 1500 comprises a container support 1510 configured to removably support or hold the storage container 106; a delivery position for the remotely operated vehicle 1200 picking-up or dropping off the storage container 106; and an elevating system 1520.

In the exemplary embodiment shown in FIGS. 5A-H, the container support 1510 is in the form of two arms 1511,1512 having a horizontal separation. The two arms 1511,1512 are L-shaped, face each other and are configured to interact with corresponding two recesses 430 of the container carrier 1210,410 of the delivery vehicle 1200,400.

The two arms 1511,1512 may have a length equal, or nearly equal, to the length of a grid cell of the rail system 110,1108,108. Alternatively, the length of the two arms may be longer than a grid cell such that the container support 1510,1511,1512 may support one or more storage containers 106.

When the remotely operated vehicle 1200,200,300,400 is at the delivery position, the container carrier 1210 and the container support 1510 are both adjacent to the storage container 106, and one of the container carriers 1210 and container support 1510 is supporting the weight of the storage container 106. The delivery position for the remotely operated vehicle 1200 picking-up or dropping-off the storage container is best illustrated by the example of FIG. 5B.

The elevating system 1520 is configured to lift and lower, or to move, the container support 1510 between a transfer position where the storage container 106 can be picked-up or dropped-off by the remotely operated vehicle 1200,200,300,400, and a storage position where the storage container 106 can be stored off the remotely operated vehicle 1200,200,300,400 on the container support 1510.

The transfer position is best illustrated in FIG. 5C, where the remotely operated vehicle 1200 is a delivery vehicle 400, and in FIG. 5H where the remotely operated vehicle is a cantilever vehicle 200, and yet further in FIG. 13D where the remotely operated vehicle 1200 is a central cavity vehicle 300.

The storage position is best illustrated in FIG. 5D, where the remotely operated vehicle 1200 is a delivery vehicle 400, and in FIG. 6C where the remotely operated vehicle is a cantilever vehicle 200, and yet further in FIG. 13A where the remotely operated vehicle 1200 is a central cavity vehicle 300.

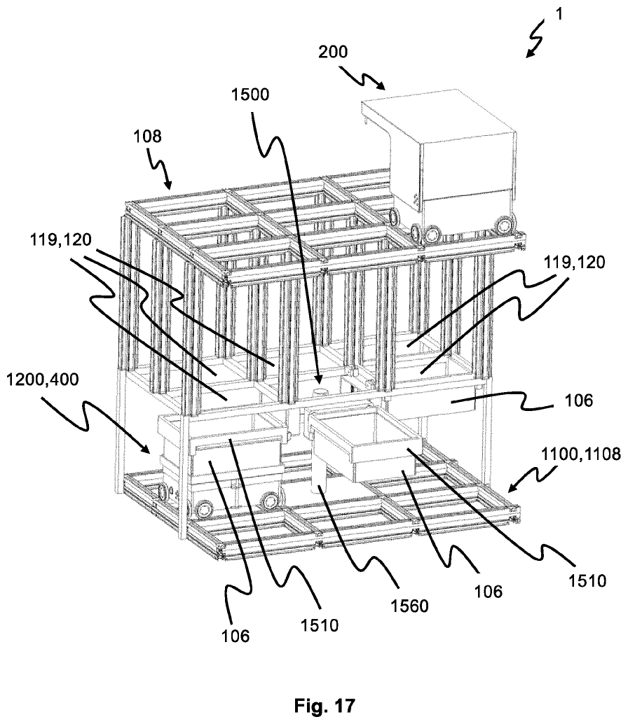

Note that the container support 1510 may be lowered below the base 1000 as shown in FIGS. 13 and 17. This configuration is particularly advantageous when the remotely operated vehicle 1200 is a central cavity vehicle 300.

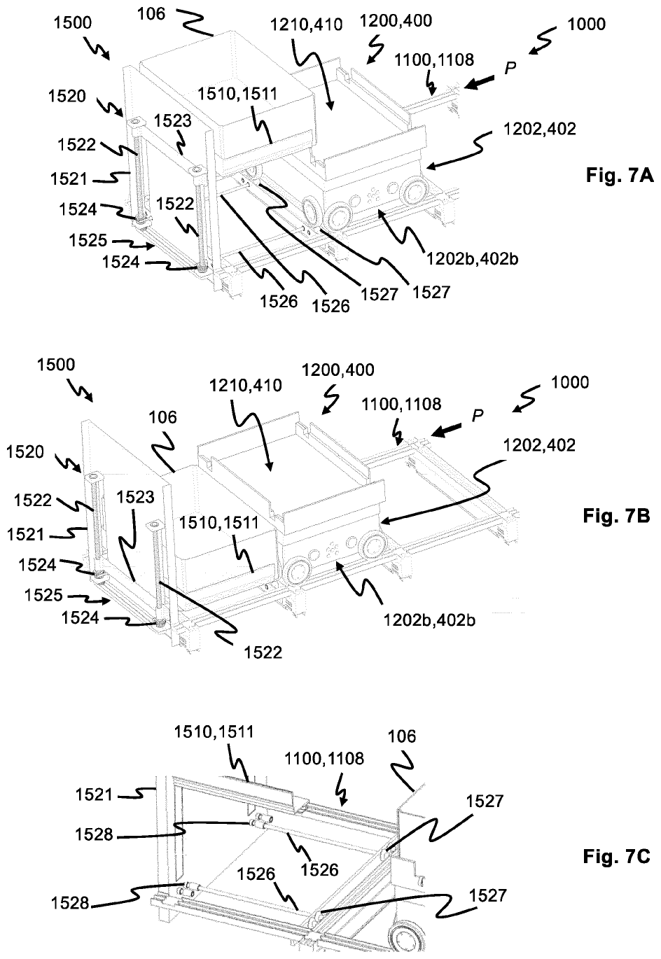

In the embodiment of FIGS. 5A-H, the elevating system 1520 is shown as a vertical elevating system 1520a configured to lift and lower the container support 1510 vertically between the transfer position and the storage position. This particular configuration of the elevating system 1520 is further described below by reference to FIGS. 7A-C.

Alternatively, the elevating system 1520 may be a pivot assembly 1520b configured to lift and lower the container support 1510 pivotally between the transfer and storage positions. This particular configuration of the elevating system 1520,1520b is further described below by reference to FIGS. 12A-F and FIGS. 13A-D.

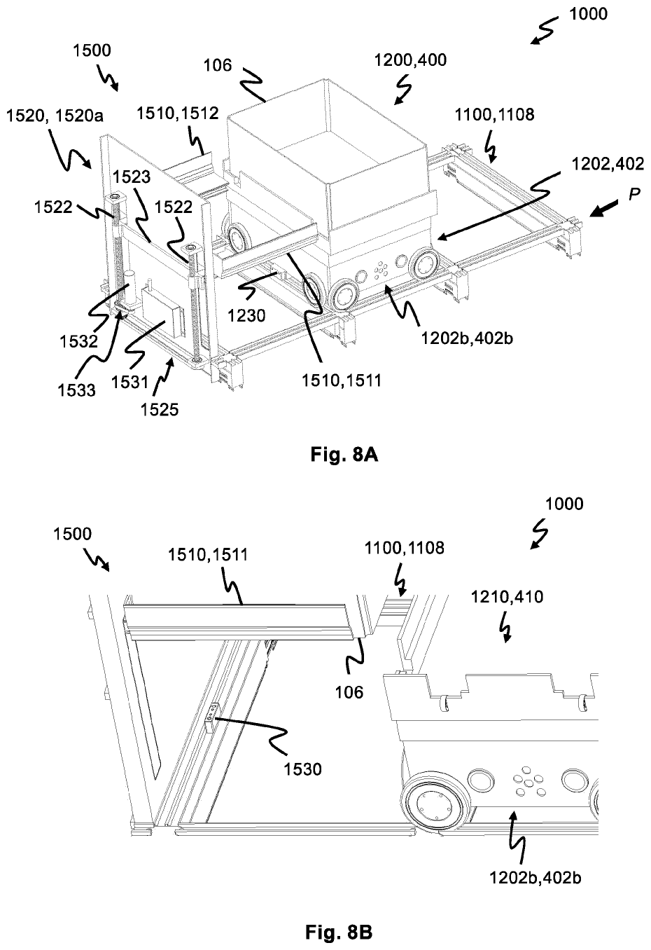

In the embodiment shown in FIG. 5A and FIGS. 5C-H the elevating system 1520 is powered by mechanical power transmitted from the rolling means 1202 of the remotely operated vehicle 1200, i.e. in this particular embodiment the rolling means 1202,402 of the delivery vehicle 1200,400. This configuration for powering the elevating system 1520 is further described below by reference to FIGS. 7A-C. Alternatively, the elevating system 1520 may be powered by electrical power transmitted from a battery onboard the delivery vehicle 1200,400 as illustrated in FIG. 5B. This particular configuration of the elevating system 1520 is further described below by reference to FIG. 8A-B.

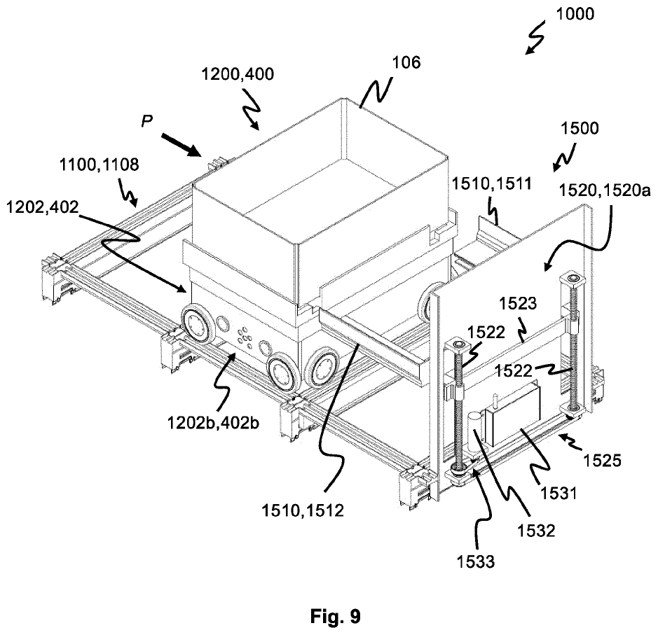

In yet another alternative, the elevating system 1520 may be powered by electrical power transmitted from a power grid. This particular configuration of the elevating system 1520 is further described below by reference to FIG. 9.

A particular advantage of the invention is that, when the remotely operated vehicle 1200,200,300,400 is in a delivery position at the storage station 1500 and the container support 1510 is in the transfer position, the storage container 106 may be transferred between the remotely operated vehicle 1200,200,300,400 and the container support 1510 of the storage station.

FIGS. 5A-H will now we used to describe a method for transferring a storage container 106 between the remote operated vehicle 1200, when the remotely operated vehicle 1200 is a delivery vehicle 400, and the storage station 1500.

FIG. 5A shows the delivery vehicle 400 approaching the storage station 1500; the container support 1510 is in a storage position. The storage container 106 is carried by the container carrier 1210,410 of the delivery vehicle 400.

FIG. 5B shows the two arms 1511,1512 in the transfer position. This is achieved by operating the elevating system 1520,1520a to move the two arms 1511,1512 from the storage position to the transfer position. In this particular embodiment, the two arms 1511,1512 are lowered from the storage position to the transfer position by operating the vertical elevating system 1520a.

FIG. 5C shows the delivery vehicle 400 in the delivery position at the storage station 1500. This is achieved by operating the delivery vehicle 400 such that it is moved to the delivery position. During this operation, the recesses 430 of the container carrier 1210,410 interact with the two arms 1510 such that the two arms 1511,1512 may be placed adjacent to two opposite lower edge of the storage container 106 without colliding with the delivery vehicle 400.

FIG. 5D shows the two arms 1511,1512 in the storage position, and the storage container 106 is supported by the two arms 1511,1512. This is achieved by operating the elevating system 1520,1520a to move the two arms 1511,1512 from the transfer position to the storage position. This configuration allows the weight of the storage container 106 to be transferred from being supported by the container carrier 1210,410 to being supported by the container support 1510—this occurs as the container support 1510 is being moved to the storage position.

FIG. 5E shows the delivery vehicle 400 leaving the storage station 1500 without the storage container 106. Hence, the storage container 106 is effectively dropped-off at the storage station 1500, and the delivery vehicle 400 may leave the station to execute other operations.

FIG. 5F shows that the two arms 1511,1512 may be lowered to a storage position such that another remotely operated vehicle 1200, for example a cantilever vehicle 200, may come and pick-up the storage container 106 from the storage station 1500.

FIG. 5G shows the cantilever vehicle 200 moved to the delivery position at the storage station.

FIG. 5H shows the two arms moved to the transfer position by operating the elevating system 1520a. In this configuration, the container carrier 210 of the cantilever vehicle grips the storage container 106 from the upper edges of the storage container 106 by activating the gripping device of the cantilever vehicle 200.

The two arms 1511,1512 may be lowered to the storage position (as best illustrated in FIG. 6A). This configuration allows the weight of the storage container 106 to be transferred from being supported by the container support 1510 to being supported by the container carrier 1210,210 of the cantilever vehicle, while the container support 1510 is moved to the storage position.

FIGS. 6A-C show perspective views of an exemplary embodiment of the invention wherein the remotely operated vehicle is a cantilever vehicle as shown in FIG. 2.

FIG. 6A shows a remotely operated vehicle 1200 that is a cantilever vehicle 200. The cantilever vehicle 200 is carrying a storage container 106, and the vehicle 200 is operating on a base 1100 that is a rail system 1108 similar to the rail system 108 as described above. The storage container 106 is carried by the container carrier 1210,210 of the cantilever vehicle 200, wherein the container carrier may be a gripping mechanism holding the storage container 106 from its upper edges.

FIG. 6A shows the cantilever vehicle 200 in the delivery position at the storage station 1500 while the container support 1510 of the storage station 1500 is in the storage position.

FIG. 6B shows the container support 1510 moved to the transfer position, i.e. the container support 1510 is below and adjacent to the storage container 106. The weight of the storage container 106 may be transferred from container carrier 210 to the container support 1510 by releasing the storage container 106 from the container carrier 1210 such that the storage container 106 is received by the container support located below the storage container 106.

FIG. 6C shows the container support 1510 in a storage position and supporting the storage container 106. The cantilever vehicle 200 may then move away from the storage station 1510 without the storage container 106. The storage container is transferred and stored at storage station 1500.

FIGS. 7A-C illustrate schematically a vertical elevating system 1520A powered by mechanical power transmitted from the rolling means 1202 of a remotely operated vehicle 1200.

In FIGS. 7A-C, the remotely operated vehicle 1200 is shown as a delivery vehicle 400 having rolling means 402. The delivery vehicle 400 is operated on a base 1100. In this exemplary embodiment, the base is a rail system 1108,108.

FIGS. 7A-C further show a storage station 1500 comprising a container support 1510 supporting a storage container 106. The storage station 1500 comprises an elevating system 1520 shown in this embodiment as a vertical elevating system 1520a.

In this embodiment, the shown vertical elevating system 1520a comprises an elevating system support 1521 and two screw shafts 1522 connected at each end to the elevating system support 1521. The two screw shafts 1522 are rotatable. In the configuration shown in FIGS. 7A-C, each screw shaft 1522 is, at one end located near the base, connected to a pinion 1524 that is configured to be driven by a force for rotating the screw shaft 1520. A bar 1523 is connected to the two screw shafts. The bar 1523 is configured to move along the two screw shafts 1520 by rotating at least one of the screw shafts 1522. In the configuration shown in FIGS. 7A-C, both screw shafts 1522 are rotated by mechanical power transmitted from the rolling means 1202,402 of the delivery vehicle 400.

The mechanical power is transmitted from the rolling means 1202,402 to the pinions 1524 by spinning one set of rolling means 1202a,402a onto two spindles 1527. The spindles 1527 are each connected to a shaft 1526 that rotates upon the rotation of the spindles 1527. At the other end of the shafts 1526, the shafts 1526 have a screw end 1528 that interacts with the pinions 1524. Upon rotation of the shaft 1526, the pinions 1524 of the screw shaft 1522 also rotate whereby the bar 1524 may move up and down along the screw shaft 1522, depending on the direction of the rotation.

The bar 1523 is connected to the container support 1510 of the storage station 1500. Thus, when the bar 1523 moves along the screw shaft 1522, the container support 1510 is also moved.

In the configuration shown in FIGS. 7A-C, the elevating support 1521, and thereby the two screw shafts 1522, are arranged perpendicular to the rail system 1108,108. When two screw shafts 1522 are rotated in one direction, the container support 1510 may be lifted above the rail system. When rotated in the two screw shafts 1522 are rotated in the opposite direction, the container support 1510 may be lowered towards a level near the rail system 1108,108.

FIG. 7A shows the container support 1510 lifted to the top of the screw shaft 1522.

FIG. 7B shows the container support 1520 lowered all the way down relative the screw shaft 1522, at a level near the rail system 1108,108.

FIG. 7C shows a detail view of the spindles 1527, shaft 1526 and screw ends of the shaft.

The pinions 1524 may be connected to each other by a rack 1525 to synchronize the rotation of the two screw shafts 1522.

FIGS. 8A-B show basically the same exemplary embodiment as the one of FIGS. 7A-C. Only difference is the vertical elevating system 1520a being powered by electrical power transmitted from a battery onboard the delivery vehicle.

In this configuration, the delivery vehicle 400 may have a first power connector 1230 and the storage station may have a second power connector 1530, wherein electrical power may be transmitted wirelessly between the first connector 1230 and the second connector 1530.

The first connector 1230 is connected to the battery (not shown) onboard the delivery vehicle 400. Electrical power is transmitted from the battery to the first connector 1230.

The second connector 1530 may be connected to a control system 1531 that is connected to a motor 1532. The motor 1532 drives the rotation of one pinion 1532 of one screw shaft 1522, and the rack 1525 transmits the rotational force to the other screw shaft 1522, such that both screw shafts 1522 are rotating synchronously to elevate or lower the container support 1510.

FIG. 9 shows the same exemplary embodiment as the one of FIGS. A-B except that the vertical elevating system 1520a is powered by electrical power transmitted from a power grid. In this configuration, the storage station 1500 has a control system 1531 that may be powered directly by electrical power from the power grid.

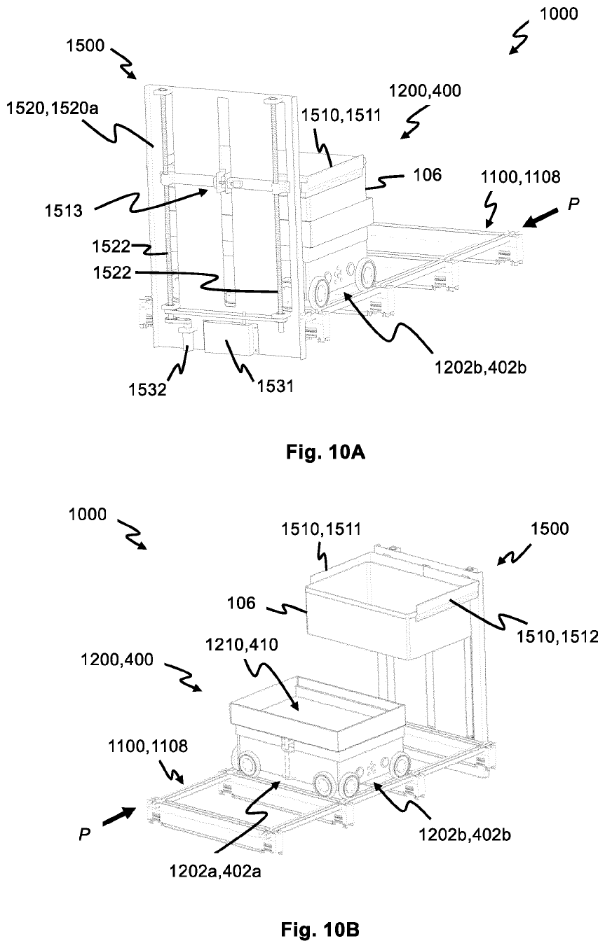

FIGS. 10A-B show a storage station 1500 and a remotely operated vehicle 1200 operating on a base 1100. In this embodiment the remotely operated vehicle 1200 is a delivery vehicle 400 and the base 1100 is a rail system 1108. Further in this embodiment, the container support 1510 uses a clamping mechanism to support the storage container 106 from the upper edges of the storage container 106.

As shown in FIGS. 10A-B, the container support 1510 is in the form of two arms 1511,1512. The container support 1510 is lifted and lowered by an elevating system 1520. In the embodiment of FIGS. 10A-B the elevating system 1520 is a vertical elevating system 1520a powered by electrical power from a power grid as described above.

The two arms 1511,1512 are configured to clamp the storage container 106 from its upper edges, for example by operating an actuator 1513.

FIG. 10A shows the delivery vehicle 400 carrying a storage container 106. The delivery vehicle is in the delivery position at the storage station 1500 and the container support 1510 is in the transfer position.

In this configuration, the container support 1510 may clamp the storage container 106 from is upper edges. The container support 1510 may be moved by the elevating system 1520a to the storage position as shown in FIG. 10B. The delivery vehicle 400 may then leave the storage station 1500 without the storage container 106, while the storage container 106 is stored at the storage station 1500.

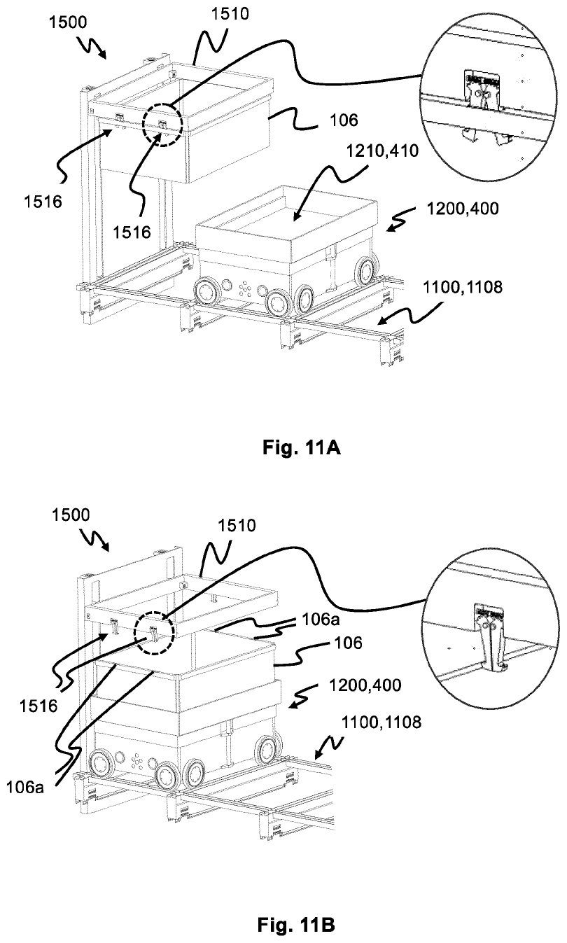

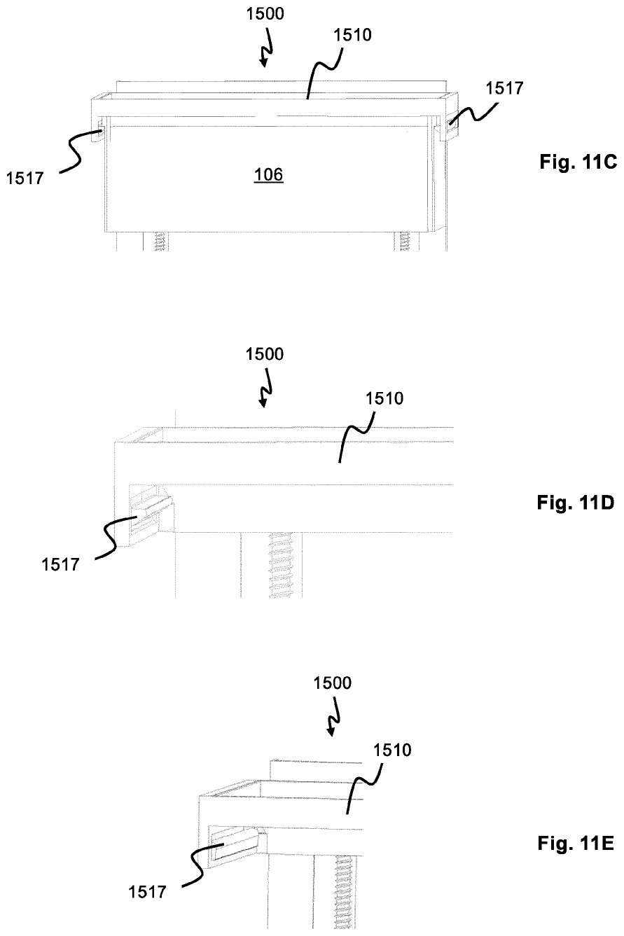

FIGS. 11A-D show perspective views of alternative configurations of the container support supporting a storage container from the upper edges of the storage container.

FIGS. 11A-B show a storage station 1500 according to an exemplary embodiment of the invention and a remotely operated vehicle 1200. In this embodiment, the remotely operated vehicle 1200 is a delivery vehicle 400 operating on a base 1100 in form of a rail system 1108.

In this configuration, the storage station 1500 has a container support 1510 configured to support a storage container 106 from its upper edges. As shown in FIGS. 11A-B, the container support 1510 may comprise gripping elements 1516 to support/hold the storage container 106 from its upper edges. The gripping elements 1516 are configured to interact with corresponding holes 106a arranged at the upper edges of the storage containers 106.

FIG. 11A shows the gripping elements 1516 in a gripping position and supporting a storage container 106. In FIG. 11A, the container support 1510 is in a storage position and the delivery vehicle 400 is arriving at the storage station 1500. In a next step, the delivery vehicle 400 may move to a transfer position at the storage station 1500. The container support 1510 may be lowered to a transfer position by activating the elevating system 1520. When the delivery vehicle 400 is in the delivery position and the container support 1510 is in the transfer position, the gripping elements 1516 may be adjusted to a release position, such that the storage container 106 is released from the gripping elements 1516 and the weight of the storage container is moved from being supported by the container support 1510 to being supported by the container carrier 410.

FIG. 11B shows the gripping element 1516 in a released position, the storage container 106 is supported by the container carrier 410 of the delivery vehicle 400, and the container support 1510 is in a storage position

FIGS. 11C-E show detailed views of an alternative mechanism for supporting the storage container 106 from the storage container 106 upper edges, by the container support 1510. In this configuration, the container support 1510 may have rotatable elements 1517.

The rotatable elements 1517 are configured to support the storage container 106 from the storage container upper edges, from opposite sides, such that the storage container is resting on the rotatable element 1517, when the rotatable elements are in a support position, as shown in FIG. 11C.

FIG. 11D shows a detail view of the rotatable element 1517 in a support position without a storage container 106 being present.

FIG. 11E shows a detail view of the rotatable elements 1517 in a release position without a storage container 106 being present.

FIGS. 12A-F show a storage station 1500 having an elevating system 1200 that is a pivot assembly 1520b, and a remotely operated vehicle 1200 operating on a base 1100, wherein the latter is a rail system 1108,108. In FIGS. 12A-F, the remotely operated vehicle 1200 is shown in a delivery position at the storage station 1500. In this configuration, the remotely operated vehicle 1200 may have four rolling means 1202 and one container carrier 1210 arranged onto the four rolling means 1202. The container carrier 1210 may comprise a base plate, a conveyor arranged on the base plate and two side walls protruding upwards from the base plate. The conveyor may be set up by inter alia a plurality of parallel oriented rolls 430 having a common longitudinal direction perpendicular to the two side walls. In this way, the rolls 430 allow one or more storage containers 106 to be shifted on or off the container carrier 410 while being guided by the side walls. The conveyor may be connected to a conveyor motor allowing rotation of one or more of the rolls.

The elevating system 1520 may comprise an elevating system support 1521 mounted onto the rail system 1108,108. The pivot assembly 1520b may be mounted onto the elevating system support 1521, as shown in FIGS. 12A-F.

The container support 1510 may be rotatably connected to the pivot assembly 1520b such that the container support 1510 can be lifted and lowered between the transfer position, where the storage container 106 can be picked-up or dropped-off by the remotely operated vehicle 1200, and a storage position, where the storage container 106 can be stored off the remotely operated vehicle 1200 on the container support 1510.

In FIG. 12A, the container support 1510 is shown in the transfer position. FIG. 12 B shows the container support 1510 in a first alternative storage position, and FIG. 12C shows the container support 1510 in a second alternative storage position.

FIGS. 12 D-F are the same as FIGS. 12A-C, but in addition FIGS. 12 D-F show two storage containers 106 supported on a pallet 1600.

In FIG. 12D, the pivot assembly 1520b has been operated such that the container support 1510 is in the transfer position. The remotely operated vehicle was then moved to the delivery position at the storage station 1500 such that the container support 1510 is arranged below the pallet 1600 supporting the storage containers 106.

In FIG. 12E, the pivot assembly 1520b has been operated such that the container support 1510 is in a storage position. In other words, the pivot assembly 1520b has lifted the container support 1510 and at the same time the weight of the pallet 1600 with the storage containers 106 is transferred from being supported by the container carrier 1210 to being supported by the container support 1510. The remotely operated vehicle 1200 may then leave the storage station 1500 without the pallet 1600 and storage containers 106. The pallet 1600 and storage containers 106 are stored at the storage station 1500.

FIGS. 13A-D show a storage station 1500 and a remotely operated vehicle 1200 operating on a base 1100 that is a rail system 1108,108. The remotely operated vehicle 1200 is shown as a delivery vehicle 400. In this embodiment, the storage station 1500 may have an elevating system 1520 in a form of a pivot assembly 1520b similar to the one described in reference to FIGS. 12A-F. In addition, the storage station 1500 may be lowered below the rail system 1108,108, using a lift mechanism 1540.

FIG. 13A shows the delivery vehicle 400 in a delivery position at the storage station 1500. The container support 1510 is positioned below the storage container 106 carried by the container carrier 410 of the delivery vehicle 400. The elevating system support 1521 is connected to the lifting mechanism 1540, such that the storage station may be lowered below the plan P of the rail system 1108.

The pivot assembly 1520b lifts the container support 1510 to the storage position such that the weight of the storage container 106 is transferred from being supported by the container carrier 410 to being supported by the container support 1510. In this configuration, the container support 1510 is in a storage position when the container support 1510 footprint is corresponding to the footprint of a grid cell of the rail system 1108,108.

The storage station 1500, which now carries the storage container 106, may then be lowered below the plan P as shown in FIG. 13B, by operating the lift mechanism 1540. The delivery vehicle 400, without the storage container 106, may leave its position to execute other operations on the rail system 1108,108.

A second remotely operated vehicle 1200, such as a central cavity vehicle 300, may be operated on the rail system to a delivery position at the storage station 1500. In this configuration, the central cavity vehicle 300 is positioned above the grid cell where the storage station 1500 is lowered, as shown in FIG. 13C.

The storage station 1500 may then be lifted by operating the lift mechanism 1540, such that the container support 1510 carrying the storage container 106 is inserted into the cavity (not shown) of the central cavity vehicle 300, as shown in FIG. 13D. The container carrier 310 of the central cavity vehicle 300 may grip the storage container using a gripping mechanism, for example using gripping elements 1516, such as the ones illustrated in FIGS. 11A-B.

The container support 1510 is further lowered to a storage position below the rail system plan P. In this process, the weight of the storage container 106 is transferred from being supported by the container support 1510 to being supported by the container carrier 310 of the central cavity vehicle 300. The central cavity vehicle 300 carrying the storage container 106 may be operated on the rail system 1108,108 to execute other tasks.

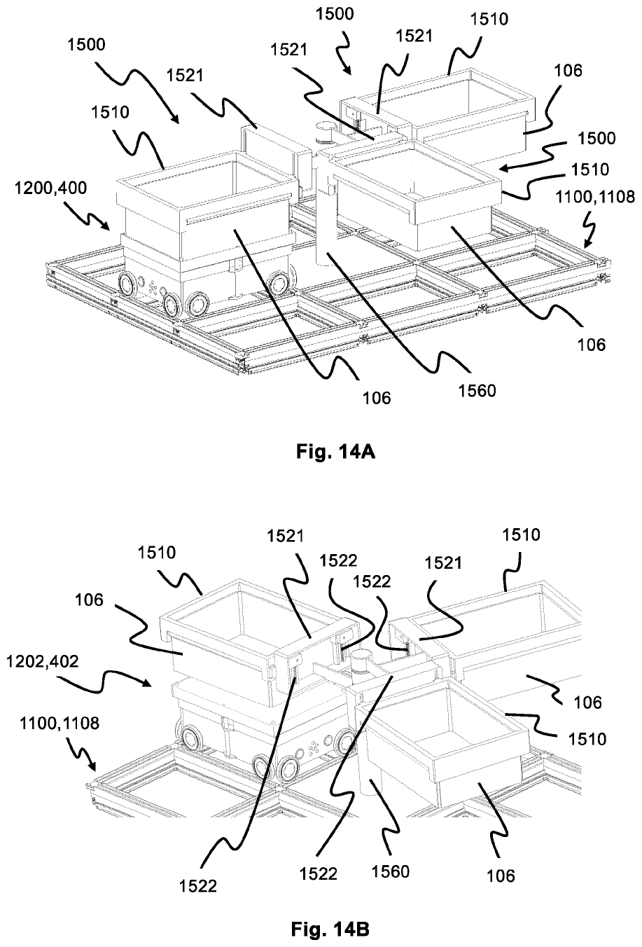

FIGS. 14A-B show three storage stations 1500 fixed to a pedestal 1560 as well as a remotely operated vehicle 1200. The pedestal 1560 may be a rotatable pedestal. In this embodiment, the remotely operated vehicle 1200 is a delivery vehicle 400 operating on a base 1100 that is a rail system 1108,108.

In FIG. 14A, the delivery vehicle 400 is shown in a delivery position at one of the storage stations 1500, and the container support 1510 of that storage station 1500 is in a transfer position.

FIG. 14B shows an alternative configuration of a plurality of storage stations 1500 fixed to a pedestal 1560. In FIG. 14B, the delivery vehicle 400 is shown in a delivery position at a storage station 1500, and the container support 1510 of that storage station 1500, if in a storage position.

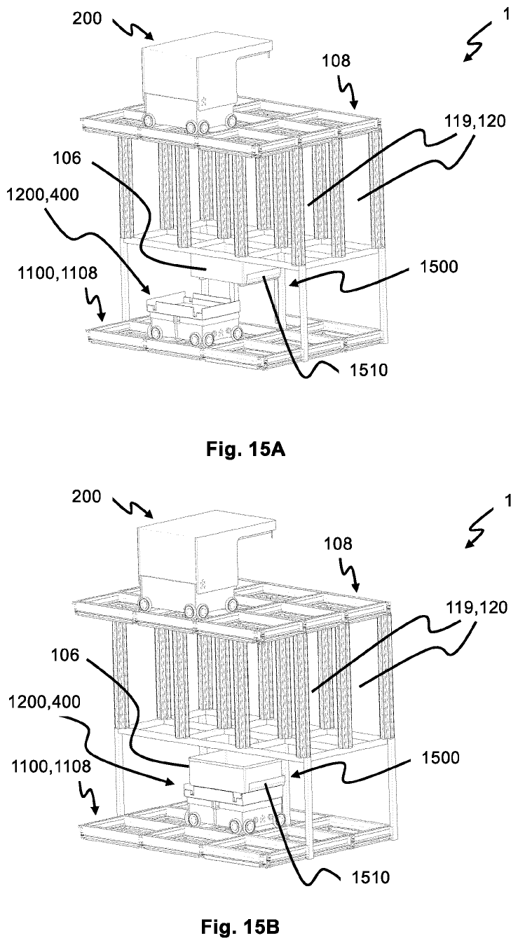

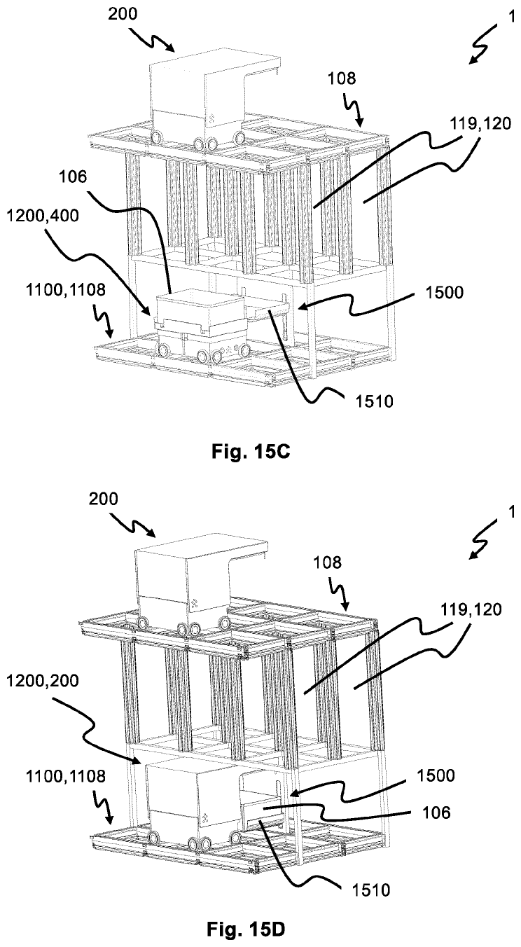

FIGS. 15A-B show an automated storage and retrieval system 1 comprising a storage container handling system 1000 as described above, an upper two-dimension rail system 108 arranged above the base 1000 of the storage container handling system.

In the embodiment shown in FIGS. 15A-B, the storage station 1500 of the storage container handling system 1000 is similar to the storage station 1500 shown in FIGS. 5 A-F.

The upper two-dimensional rail system 108 comprises a first set of parallel rails 110 arranged in a horizontal plane P and extending in a first direction X, and a second set of parallel rails 111 arranged in the horizontal plane P and extending in a second direction Y perpendicular to the first direction X. Said first and second sets of rails 110,111 forming a grid pattern in the horizontal plane P comprising a plurality of adjacent grid cells 122, each grid cell 122 comprising a grid opening 115. The two-dimensional rail system 108 further comprises a plurality of stacks 107 of storage containers 106 arranged in storage columns 105 beneath the upper rail system 108, wherein each storage column 105 is located vertically below the grid opening 115.

The two-dimensional rail system 108 further comprises a delivery column 119,120 for transport of the storage container 106 between the upper rail system 108 and the storage station 1500, wherein the storage station 1500 is arranged at the base 1000 at the lower end of the delivery column 119,120.

The automated storage and retrieval system 1 comprises container handling vehicles 200,300. The container handling vehicles 200,300 comprise a lifting device 304 for lifting storage containers 106 stacked in stacks 107 and configured to drive the vehicle along the upper rail system 108 in at least one of the first direction X and the second direction Y.

FIG. 15A shows a delivery vehicle 400 operating on the base 1100,1108 arriving at the storage station 1500. The delivery vehicle 400 does not carry a storage container 106. The storage station 1500 below the delivery column 119,120 comprises a container support 1510 that is in a storage position. The container support 1510 of the storage station 1500 is shown as supporting a storage container 106 to be transferred to delivery vehicle 400. The storage container 106 has been dropped on the container support 1510 by the cantilever vehicle 200 operating on the upper rail system 108.

FIG. 15B shows the delivery vehicle 400 in the delivery position at the storage station such that the delivery vehicle may pick-up the storage container 106 from the storage station 1500.

FIG. 15C shows the delivery vehicle 400 leaving the storage station 1500 with the storage container.

Alternatively, instead of a delivery vehicle 400, a cantilever vehicle 200 may be operated to pick-up the storage container 106 from the storage station 1500, as shown in FIG. 15D.

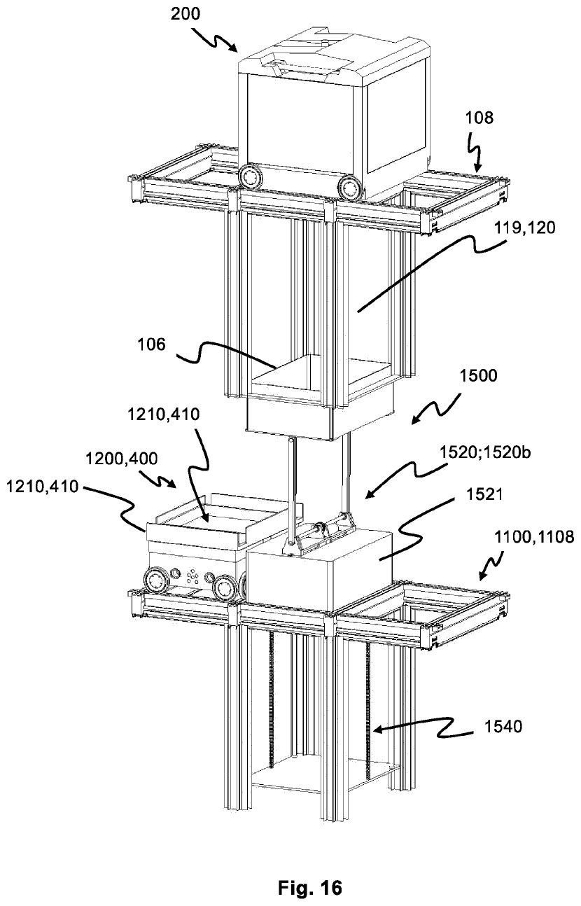

FIG. 16 shows a similar embodiment to the one of FIG. 15. The only difference is that in the embodiment shown in FIG. 16, the storage station 1500 is a storage station as shown in FIG. 13.

FIG. 17 shows a similar embodiment to the one of FIG. 15. The only difference is that in the embodiment shown in FIG. 17, the storage station 1500 is a storage station as shown in FIG. 14.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
103 Horizontal members of framework structure
104 Storage grid
105 Storage column
106 Storage container
106′ Particular position of storage container
106a Hole
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
200 Prior art container handling vehicle with cantilever
201 Vehicle body of the vehicle 200
202 Drive means of the vehicle 200
202a Drive means/wheel arrangement, first direction (X)
202b Drive means/wheel arrangement, second direction (Y)
210 Storage container lifting device
300 Prior art container handling vehicle occupying a single cell
301 Vehicle body of the vehicle 300
302 Drive means of the vehicle 300
302a Drive means/wheel arrangement, in first direction (X)
302b Drive means/wheel arrangement, in second direction (Y)
304 Gripping device
400 Delivery vehicle
401 Vehicle body of the vehicle 400
402 Drive means of the vehicle 400
402a Drive means/wheel arrangement, in first direction (X)
402b Drive means/wheel arrangement, in second direction (Y)
410 Container carrier
420 Container supporting device
430 Recess
500 Control system
1000 Storage container handling system
1100 Base
1108 Two-dimensional rail system
1110 Parallel rails in first direction (X)
1111 Parallel rails in second direction (Y)
1115 Grid opening
1122 Grid cell
1200 Remotely operated vehicle
1201 Body of the remotely operated vehicle 1400
1202 Drive means of the vehicle 1400
1202a Drive means/wheel arrangement, in first direction (X)
1202b Drive means/wheel arrangement, in second direction (Y)
1210 Container carrier
1230 Power connector
1240 Conveyor roller
1500 Temporary storage station
1510 Container support
1511 First arm of container support 1510
1512 Second arm of container support 1510
1513 Actuator
1515 Clamping arms
1516 Gripping element
1517 Rotatable element
1520 Elevating system
1520a Vertical elevating system
1520b Pivot assembly
1521 Elevating system support
1521a Support plate
1521b Support base
1522 Screw shaft
1523 Bar
1524 Pinion
1525 First rack and pinion assembly
1526 Shaft
1527 Spindle
1528 Screw end
1530 Power Connector
1531 Control device/system of the storage station
1532 Motor
1533 Second rack and pinion assembly
1540 lift mechanism
1560 Pedestal
1600 Pallet
X First direction
Y Second direction
Z Third direction

1. A storage container handling system comprising:
a base,
a remotely operated vehicle comprising rollers configured to operate the remotely operated vehicle on the base, the remotely operated vehicle comprising at least one container carrier configured to carry a storage container;
a storage station for storing a storage container that is to be picked-up by or dropped off by the remotely operated vehicle, the storage station comprising:
a container support configured to support the storage container;
a delivery position for the remotely operated vehicle picking-up or dropping off the storage container; and
an elevating system configured to lift and lower the container support between a transfer position, where the storage container can be picked-up or dropped off by the remotely operated vehicle, and a storage position, where the storage container can be stored off the remotely operated vehicle on the container support,
wherein the elevating system is a vertical elevating system configured to lift and lower the container support vertically between the transfer position and the storage position such that, when the remotely operated vehicle is in the delivery position at the storage station and the container support is in the transfer position, the storage container may be transferred between the remotely operated vehicle and the container support of the storage station, and
wherein the elevating system is powered by mechanical power transmitted from the rollers of the remotely operated vehicle.

2. The storage container handling system according to claim 1, wherein the elevating system is powered by electrical power transmitted from a battery onboard the remotely operated vehicle.

3. (canceled)

4. (canceled)

5. The storage container handling system according to claim 1, wherein the container support is configured to support the storage container from below.

6. The storage container handling system according to claim 1, wherein the container support is configured to support the storage container from lower edges of the storage container.

7. The storage container handling system according to claim 1, wherein the container support is configured to support the storage container from upper edges of the storage container.

8. The storage container handling system according to claim 1, wherein the container support is in the form of two arms having a horizontal separation.

9. (canceled)

10. The storage container handling system according to claim 7, wherein the container support comprises a gripping device configured to interact with corresponding holes of the storage container.

11. The storage container handling system according to claim 1, wherein the container support comprises a clamping device configured to hold the storage container from at least two opposite sides.

12. The storage container handling system according to claim 1, wherein the storage station is configured such that the container support is tiltable.

13. (canceled)

14. The storage container handling system according to claim 13, wherein the pedestal is configured to be height adjustable relative to the base.

15. The storage container handling system, according to claim 13, wherein the pedestal is configured to be rotatable around its longitudinal axis.

16. The storage container handling system according to claim 1, wherein the base is a first two-dimensional rail system comprising:
a first set of parallel rails arranged in a horizontal plane and extending in a first direction, and
a second set of parallel rails (1111) arranged in the horizontal plane and extending in a second direction which is perpendicular to the first direction, said first and second sets of rails forming a grid pattern in the horizontal plane comprising a plurality of adjacent grid cells, each grid cell comprising a grid opening.

17. An automated storage and retrieval system comprising:
a storage container handling system according to claim 1,
an upper two-dimensional rail system arranged above the base of the storage container handling system, comprising:
a first set of parallel rails arranged in a horizontal plane and extending in a first direction, and a second set of parallel rails arranged in the horizontal plane and extending in a second direction perpendicular to the first direction, said first and second sets of rails forming a grid pattern in the horizontal plane comprising a plurality of adjacent grid cells, each grid cell comprising a grid opening,
a plurality of stacks of storage containers arranged in storage columns beneath the upper rail system, wherein each storage column is located vertically below the grid opening;
a container handling vehicle comprising a lifting device for lifting a storage container stacked in the stacks and configured to drive the vehicle along the upper rail system in at least one of the first direction and the second direction, and
a delivery column for transport of the storage container between the upper rail system and the storage station, wherein the storage station is arranged at the base at the lower end of the delivery column or fixed on the two-dimensional rail system.

18. (canceled)

19. A method of transferring a storage container between a remotely operated vehicle and a storage station of a storage container handling system according to claim 1, wherein the remotely operated vehicle is configured to move on the base and wherein the elevating system is a vertical elevating system configured to lift and lower the container support vertically between the transfer position and the storage position,
the method comprising:
a) operating the elevating system such that the container support is in the transfer position,
b) moving the remotely operated vehicle to the delivery position at the storage station;
c) transferring the storage container from the remotely operated vehicle to the container support of the storage station by operating the elevating system to vertically move the container support from the transfer position to the storage position, and
d) moving the remotely operated vehicle in an opposite direction relative to b), and
e) powering the elevating system by mechanical power transmitted from the rollers of the remotely operated vehicle.
